(19) United States
(12) Patent Application Publication
(10) Pub. No.: US 2014/0289787 A1
(43) Pub. Date: Sep. 25, 2014

(54) COMMUNICATION DEVICE, COMMUNICATION METHOD, AND COMPTER PROGRAM PRODUCT

(71) Applicant: Kabushiki Kaisha Toshiba, Tokyo (JP)

(72) Inventors: Takashi Minemura, Ome-shi (JP); Tomohiro Kanda, Saitama-shi (JP)

(73) Assignee: Kabushiki Kaisha Toshiba, Tokyo (JP)

(21) Appl. No.: 14/216,667

(22) Filed: Mar. 17, 2014

Related U.S. Application Data
(63) Continuation of application No. PCT/JP2013/058386, filed on Mar. 22, 2013.

(51) Int. Cl. H04N 21/238; H04N 21/41; H04N 21/61

(52) U.S. Cl. CPC H04N 21/238; H04N 21/6156; H04N 21/4126
USPC 725/116

(57) ABSTRACT

According to one embodiment, communication device includes communication module, mode setting module, receiver, transmission setting module, and reporting module. The mode setting module sets operation mode relating to reproduction of the content. The transmission setting module sets, based on capability of the communication and corresponding devices and within range capable of transmitting the content at transmission rate based on communication state of wireless transmission, at least one of scaling adjustment and frame rate adjustment to be performed by one of the communication and corresponding devices with superior capability. The scaling adjustment and the frame rate adjustment are performed on the content upon transmission of the content when the content is reproduced in the operation mode. The reporting module reports, when the at least one of the scaling adjustment and the frame rate adjustment is set to be performed by the corresponding device, the setting to the corresponding device.

### CROSS-REFERENCE TO RELATED APPLICATIONS

This application is a continuation of International Application No. PCT/JP2013/058386, filed Mar. 22, 2013, which designates the United States, the entire contents of which are incorporated herein by reference.

### FIELD

Embodiments described herein relate generally to a communication device, a communication method, and a computer program product.

### BACKGROUND

Conventionally, there has been existing a communication device such as a content transmitting device (source device) or a content receiving device (sink device) that transmit and receive a content file (content) with video information, audio information, or information combining them, between electronic devices such as a television receiver, a recorder and a tablet terminal. Such communication device wirelessly transmits the content via, for example, a wireless local area network (LAN), from the source device to the sink device to reproduce the content on the sink device.

However, the above conventional technique cannot reproduce content at the setting desired by a user, such as an image-quality priority setting, a frame-rata priority setting, a low-delay setting, and a power-saving setting, and also at a frame rate or scaling according to the communication state of the wireless transmission which is likely to be influenced by environment factors such as communication distance and the like.

### BRIEF DESCRIPTION OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary explanatory diagram illustrating a schematic configuration of one example of a system comprising a communication device according to an embodiment;

FIG. 2 is an exemplary block diagram illustrating one example of a functional configuration of communication devices in the embodiment;

FIG. 3A is an exemplary block diagram illustrating a configuration relating to video processing on a transmission-side communication device in the embodiment;

FIG. 3B is an exemplary block diagram illustrating a configuration relating to video processing on a reception-side communication device in the embodiment;

FIG. 4 is an exemplary flowchart illustrating one example of the operation of the communication device in the embodiment;

FIG. 5 is an exemplary flowchart illustrating one example of user setting determination processing in the embodiment;

FIG. 6 is an exemplary schematic diagram exemplifying filtering at capability exchange in the embodiment; and

FIG. 7 is an exemplary flowchart illustrating one example of transmission method determination processing in the embodiment.

### DETAILED DESCRIPTION

In general, according to one embodiment, a communication device includes a communication module, a mode setting module, a receiver, a transmission setting module, and a reporting module. The communication module is configured to wirelessly transmit content. The mode setting module is configured to set one of operation modes relating to reproduction of the content. The receiver is configured to receive pieces of information indicating capabilities from a corresponding device to which the content is transmitted. The transmission setting module is configured to set, based on capability of the communication device and the corresponding device and within a range capable of transmitting the content at a transmission rate that is based on a communication state of the wireless transmission, at least one of scaling adjustment and frame rate adjustment to be performed by one of the communication device and the corresponding device with superior capability. The scaling adjustment and the frame rate adjustment are configured to be performed on the content upon transmission of the content when the content is reproduced in the set one of the operation modes. The reporting module is configured to report, when the at least one of the scaling adjustment and the frame rate adjustment is set to be performed by the corresponding device, the setting to the corresponding device.

The following describes a communication device, a communication method, and a computer program according to an embodiment in detail with reference to the attached drawings.

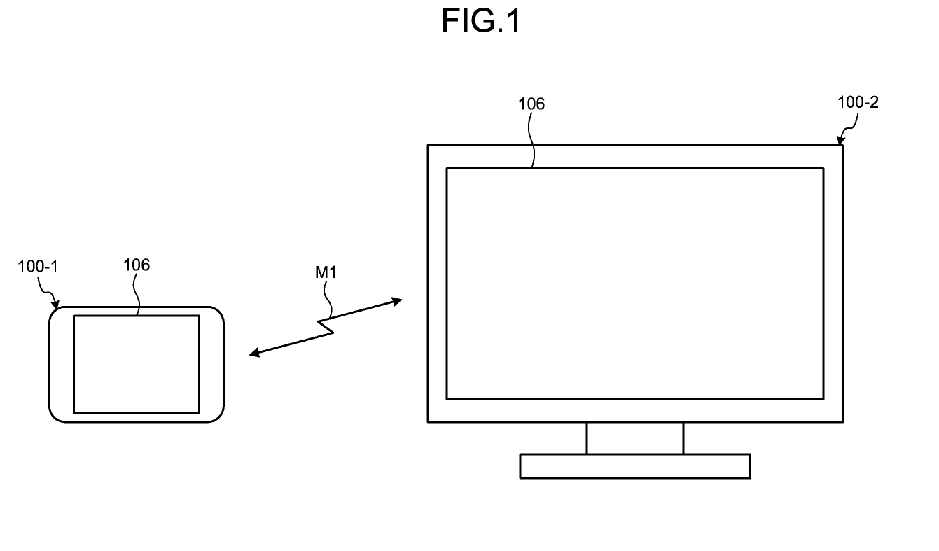

FIG. 1 is an explanatory diagram illustrating a schematic configuration of one example of a system comprising communication devices 100-1, 100-2 according to the embodiment. As illustrated in FIG. 1, the communication device 100-2 is a television receiver having a display 106 such as a liquid crystal display. The communication device 100-1 is a tablet terminal having the display 106 such as a liquid crystal display on which a touch panel is stacked.

The communication devices 100-1, 100-2 are connected mutually communicably through a wireless line M1. Specifically, the wireless line M1 may be a wireless LAN at 60 GHz band, 5 GHz band, or 2.5 GHz band such as WirelessHD (the IEEE 802.11 series or the like). The present embodiment exemplifies the configuration of the communication devices 100-1, 100-2 being directly connected through the wireless line M1. They may be connected through a relay (not illustrated) such as a wireless LAN access point.

The communication device 100-1 transmits to the communication device 100-2 video signals (image data) and audio signals (audio data) attached thereto of content such as a program received through terrestrial digital broadcasting or the like through the wireless line M1. The communication device 100-2 can receive the video signals and the audio signals transmitted from the communication device 100-1, and output (reproduce) video and audio relating to the video signals and the audio signals. The transmission of the content from the communication device 100-1 to the communication device 100-2 and the reproduction of the content on the communication device 100-2 may be performed reversely. Specifically, the transmission of the content may be performed from the communication device 100-2 to the communication device 100-1, and the content may be reproduced on the communication device 100-1.

The communication devices 100-1, 100-2 are compliant with a technology called digital living network alliance (DLNA) that realizes interoperability of digital home network devices, and both of them are compliant with content protection methods such as DTCP-IP, High-bandwidth Digital Content Protection (HDCP), and Serial Copy Management System (SCMS). In other words, the communication device 100-1 corresponds to a source device in DLNA, and the communication device 100-2 corresponds to a sink device in DLNA. The communication device 100-1 can transmit content such as a program received through terrestrial digital broadcasting or the like to the communication device 100-2 while keeping its copyright protected. Another content transmission method in addition to the above one may be one using a wireless image rendering technology such as Wi-Fi Display.

The present embodiment exemplifies a general television receiver as the communication device 100-2 and a general tablet terminal as the communication device 100-1. It is needless to say that the communication devices 100-1, 100-2 may be devices such as a hard disk recorder and a set-top box, so long as they are devices that transmit and receive content such as a program received through terrestrial digital broadcasting or the like.

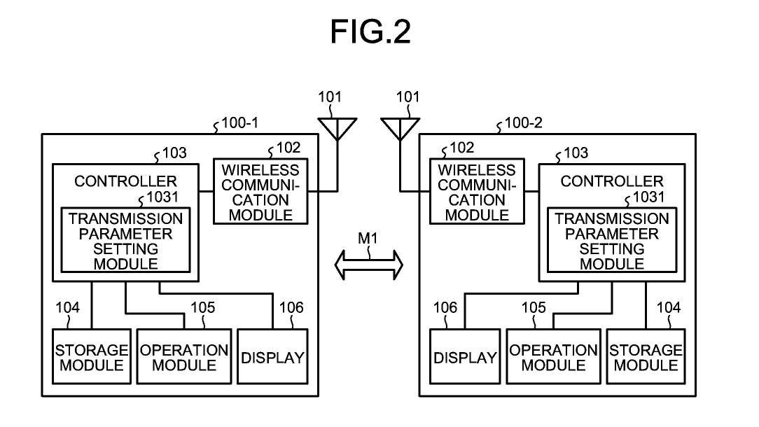

FIG. 2 is a block diagram illustrating an example of functional configurations of the communication devices 100-1, 100-2 according to the embodiment. As illustrating in FIG. 2, the communication devices 100-1, 100-2 comprise: a wireless communication module 102 that performs wireless communications through an antenna 101; and a controller 103 that controls the operation of the wireless communication module 102.

The wireless communication module 102 performs the transmission and reception of content through the wireless line M1 standardized with IEEE 802.11 or the like. The controller 103 comprise a central processing unit (CPU), a random access memory (RAM), and a read only memory (ROM), and the CPU loads computer programs stored in the ROM into the RAM and successively executes them, thereby controlling operations of the communication device. Examples of the operations the controller 103 controls comprise the control of transmission and reception of content through the wireless line M1 and the control of scaling adjustment and frame rate adjustment on content in an image processor (not illustrated) such as a digital signal processor (DSP). A display panel of the display 106 of the communication device 100-2 is capable of 4K (4096×2160 pixels) display. Accordingly, for the scaling adjustment, the communication device 100-2 has a capability of upscaling content with a resolution of less than 4K to a resolution 4K. The CPU successively executes the computer programs, thereby causing the controller 103 to provide a function as a transmission parameter setting module 1031.

The transmission parameter setting module 1031 is a functional module that sets at least one of scaling adjustment and frame rate adjustment to be performed by one of the communication device and a corresponding device. Here, the scaling adjustment and the frame rate adjustment are performed on the content upon transmission of the content when the content is reproduced based on the operation mode according to the reproduction of the content set by the operation of the user via, for example, an operation module 105. Specifically, the transmission parameter setting module 1031 sets, based on capability of the communication device and the corresponding device and within a range capable of transmitting the content at a transmission rate that is based on a communication state of the wireless line M1 of the wireless communication module 102, at least one of the scaling adjustment and the frame rate adjustment to be performed by one of the communication device and the corresponding device with superior capability. Here, the present embodiment describes the communication device 100-1 as the source device being on the communication device side that performs processing and the communication device 100-2 as the sink device being on the corresponding device side. It is needless to say that the communication device 100-2 as the sink device may be on the communication device side that performs processing and that the communication device 100-1 as the source device may be on the corresponding device side.

The operation mode relating to the reproduction of content comprises an image-quality priority mode, a frame-rate priority mode, a low-delay mode, and a power-saving mode. The image-quality priority mode is a mode in which image quality is prioritized for content reproduction. Specifically, in the mode, operation is performed so that resolution is not impaired by prohibiting downscaling, and when upscaling, higher-quality filtering processing is performed. The frame-rate priority mode is a mode in which a frame rate is increased for content reproduction. Specifically, in the mode, operation is performed so that no decrease in frame rate is brought about by prohibiting skipping, and when the frame rate is a predetermined frame rate or less, frame interpolation is performed. The low-delay mode is a mode in which a delay time is reduced for content reproduction. Specifically, in the mode, operation is performed so that the processing time in scaling adjustment and frame rate adjustment is kept at a certain period of time or less. The power-saving mode is a mode in which power consumption is reduced for content reproduction. Specifically, in the mode, operation is performed so that the power consumption of a device is kept at a certain value or less in accordance with the presence or absence of scaling adjustment and frame rate adjustment.

The communication devices 100-1, 100-2 may comprise a storage module 104, the operation module 105, and the display 106. The storage module 104 is a nonvolatile memory or the like that stores therein various kinds of setting information for the controller 103 to perform control. One of the various kinds of setting information stored in the storage module 104 is user setting information indicating the file name of content or the name of program software that reproduces the content and an operation mode corresponding to the file name or the name of the program software. The operation module 105 comprises operating keys and a touch panel that receive user operations. The display 106 comprises a liquid crystal display that performs screen display under control of the controller 103.

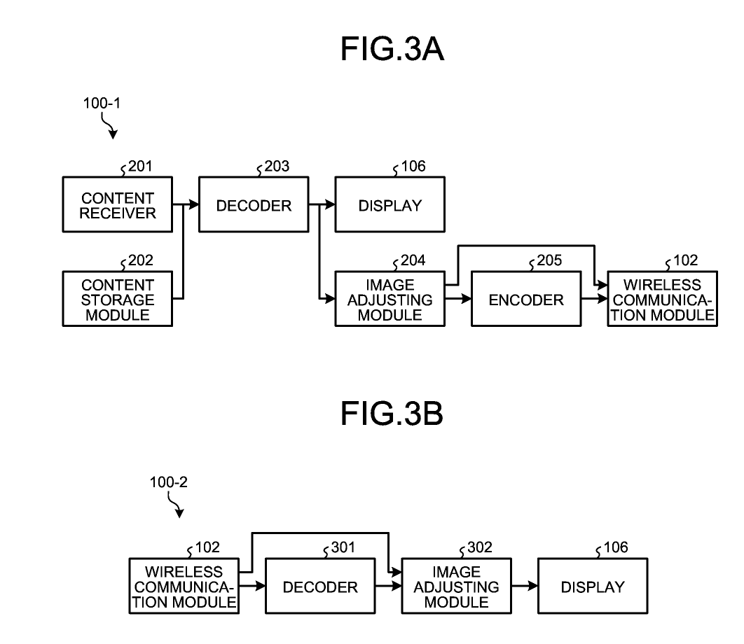

FIG. 3A is a block diagram illustrating the configuration of the communication device 100-1 on a transmission side. As illustrated in FIG. 3A, the communication device 100-1 comprises a content receiver 201, a content storage module 202, a decoder 203, the display 106, an image adjusting module 204, an encoder 205, and the wireless communication module 102. The content receiver 201 comprises a tuner that receives image signals (image data) of content such as a program of terrestrial digital broadcasting or the like and a communication module that receives video signals (image data) of IP TV broadcasting distributed through a network. The content storage module 202 stores therein the image data. The decoder 203 has a function of decoding encoded image data input from the content receiver 201 and the content storage module 202. The decoder 203 outputs the decoded image data to the display 106 and causes the display 106 to display it.

When transferring video displayed on the display 106 to the communication device 100-2, the decoder 203 also outputs the decoded image data to the image adjusting module 204. The image adjusting module 204 has a scaling function, a frame rate adjustment function, an image quality adjustment function, and the like, and determines whether to perform these functions in accordance with a setting determined by the controller 103, and executes any function according to need. The encoder 205 encodes the image data processed by the image adjusting module 204. The wireless communication module 102 packetizes the encoded imaged data obtained by encoding, into a format suitable for image transfer and transmits the image data to the communication device 100-2. Alternately, the wireless communication module 102 transmits the image data from the image adjusting module 204 to the communication device 100-2 in an uncompressed manner. Through the foregoing processing, the communication device 100-1 can transmit the video displayed on the display 106 to the communication device 100-2. In other words, the communication device 100-1 can capture data of the video displayed on the display 106 and transmit the captured video data to the communication device 100-2. The communication device 100-1 may transmit the video to the communication device 100-2 without displaying the video on the display 106.

FIG. 3B is a block diagram illustrating the configuration of the communication device 100-2 on a reception side. As illustrated in FIG. 3B, the communication device 100-2 comprises the wireless communication module 102, a decoder 301, an image adjusting module 302, and the display 106. The wireless communication module 102 receives the coded image data or the uncompressed image data transmitted from the communication device 100-1. The decoder 301 decodes the encoded image data. The image adjusting module 302 performs scaling processing and frame rate processing on the image data from the wireless communication module 102 or the image data from the decoder 301 in accordance with a setting of the controller 103. The display 106 displays the image with the processing performed.

The following describes a flow of process performed under control of the controller 103 of the communication device 100-1 when content is transmitted from the communication device 100-1 to the communication device 100-2 and is reproduced.

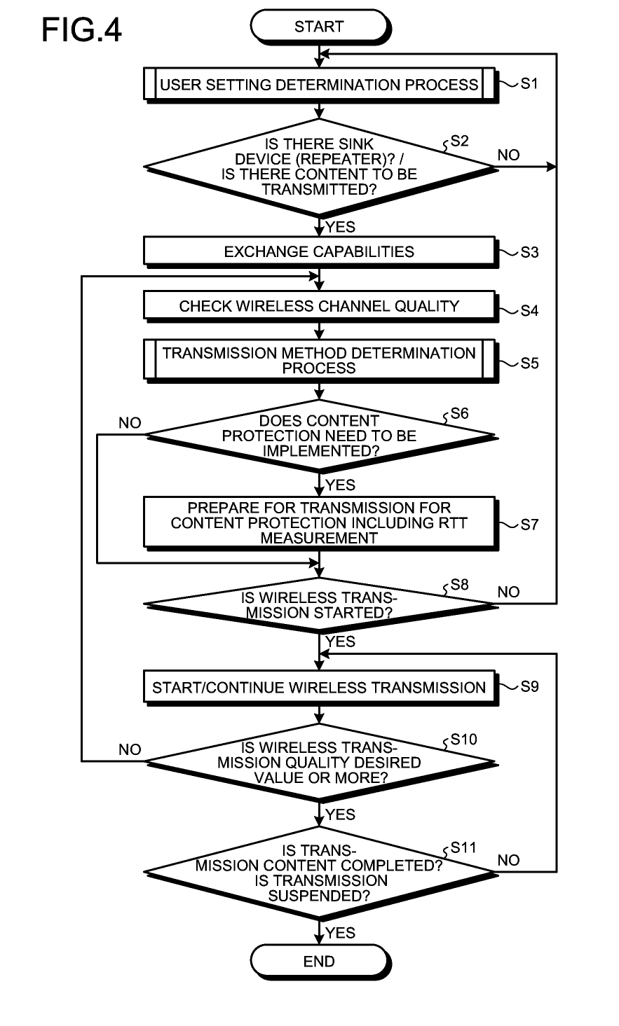

FIG. 4 is a flowchart illustrating an example of the operation of the communication device 100-1 according to the embodiment. As illustrated in FIG. 4, upon starting of the processing, the controller 103 performs user setting determination processing that determines a user setting on an operation mode (S1).

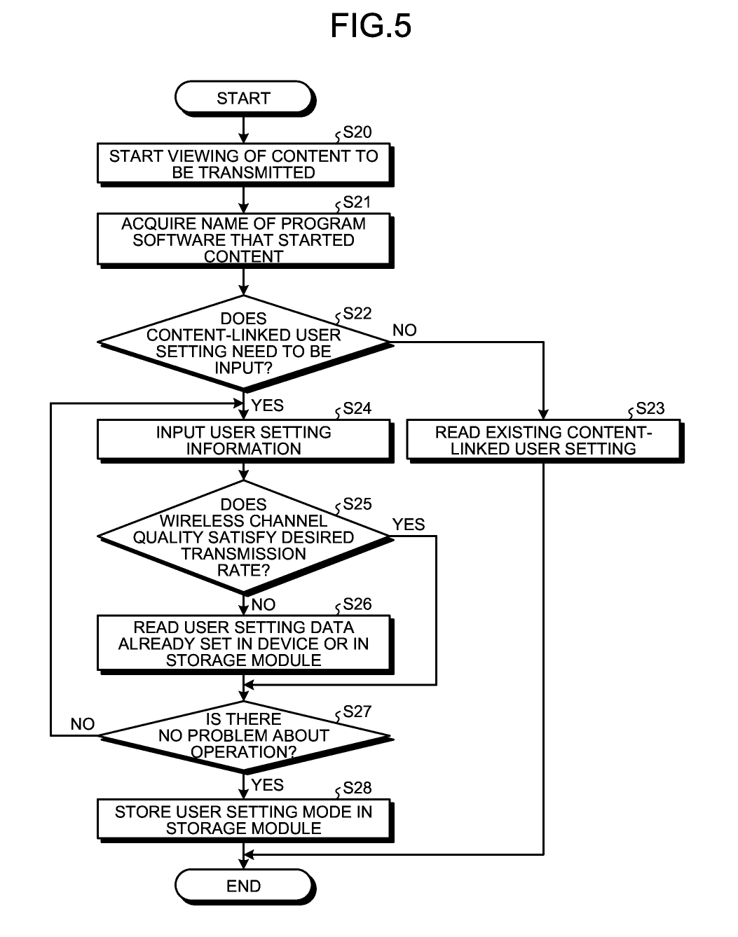

FIG. 5 is a flowchart illustrating an example of the user setting determination processing. As illustrated in FIG. 5, upon starting of the user setting determination processing, based on a selection operation on content by the operation module 105 or the like, the controller 103 starts program software that reproduces the content and starts the viewing (reproduction) of the content to be transmitted (S20).

The controller 103 then acquires the name of the started program software (S21), and determines whether a content-linked user setting needs to be input (S22). Specifically, the controller 103 refers to the user setting information stored in the storage module 104 based on the acquired name of the program software, and determines whether an operation mode corresponding to the name of the program software is stored. If the operation mode corresponding to the name of the program software is stored, the operation mode corresponding to the name of the program software is already set, and the user setting does not need to be input (No at S22). If the operation mode corresponding to the name of the program software is not stored, the operation mode corresponding to the program software is not yet set, and the user setting needs to be input (Yes at S22).

The present embodiment exemplifies a configuration that the name of the started program software is acquired to determine whether the operation mode corresponding to the name of the program software is stored in the user setting information. It is needless to say that the name of the content may be used in place of the name of the program software.

If the user setting does not need to be input (No at S22), the controller 103 reads the operation mode corresponding to the name of the program software as an existing content-linked user setting (S23), and ends the process.

If the user setting needs to be input (Yes at S22), the controller 103 receives an input of user setting information indicating the operation mode such as the image-quality priority mode, the frame-rate priority mode, the low-delay mode, or the power-saving mode based on a selection operation by the operation module 105 or the like (S24). The controller 103 then determines whether the quality (communication state) of the wireless line M1 satisfies a desired transmission rate that is a transmission rate of when the content is reproduced in the received operation mode (S25).

Specifically, the controller 103 calculates a transmission rate allowed in the transmission through the wireless line M1 based on information on signal intensity in the wireless communication module 102 or the like, and determines whether the transmission rate exceeds a transmission rate estimated based on the received operation mode (the image-quality priority mode, the frame-rate priority mode, the low-delay mode, or the power-saving mode). In the estimation of the transmission rate based on the received operation mode (the image-quality priority mode, the frame-rate priority mode, the low-delay mode, or the power-saving mode), the transmission rate is estimated for the case of transmitting content after performing scaling adjustment and frame rate adjustment according to the operation mode on the source device (the communication device 100-1) side.

If the quality (communication state) of the wireless line M1 satisfies the desired transmission rate (Yes at S25), the content can be transmitted even when the content is reproduced in the received operation mode. After determining whether there is no problem about operation (S27), if there is no problem (Yes at S27), the controller 103 stores as a user setting operation mode in the storage module 104 together with the file name of the content or the name of the program software that reproduces the content (S28).

If the quality (communication state) of the wireless line M1 does not satisfy the desired transmission rate (No at S25) and when the content is reproduced in the received operation mode, the quality (communication state) of the wireless line M1 is not suitable for the transmission of the content, thereby block noise or the like is likely to be caused. If the quality (communication state) of the wireless line M1 does not satisfy the desired transmission rate (No at S25), accordingly, the controller 103 reads user setting data (operation mode) already set in the device or set in the storage module 104 (S26), and determines whether there is no problem about operation (S27). If there is no problem (Yes at S27), the controller 103 stores the user setting data (operation mode) as a user setting operation mode in the storage module 104 together with the file name of the content or the name of the program software that reproduces the content (S28). If there is any problem at S27 (No at S27), the controller returns the process to S24.

Returning back to FIG. 4, following S1, the controller 103 determines whether the sink device (repeater) is present and content to be transmitted is present based on communication with the wireless communication module 102 and the presence or absence of the content selected to be transmitted (S2). If the sink device (repeater) is absent and content to be transmitted is absent (No at S2), the controller 103 returns the process to S1 because content reproduction cannot be performed on the sink device side.

If the sink device (repeater) is present and there exists content to be transmitted (Yes at S2), the controller 103 performs the exchange of information indicating a capability with the communication device 100-2 as the corresponding device with which the transmission and reception of the content are performed, that is, a capability exchange through communication with the wireless communication module 102 (S3). This capability exchange allows reception of information on hardware resources (a display size, resolution, a frame-rate upper limit value, an operation capability (operation time), power consumption, the presence or absence of a battery, and the like) and software resources (upscaling performance, image filter performance, a frame interpolation capability, and a skipping capability) on the corresponding device side.

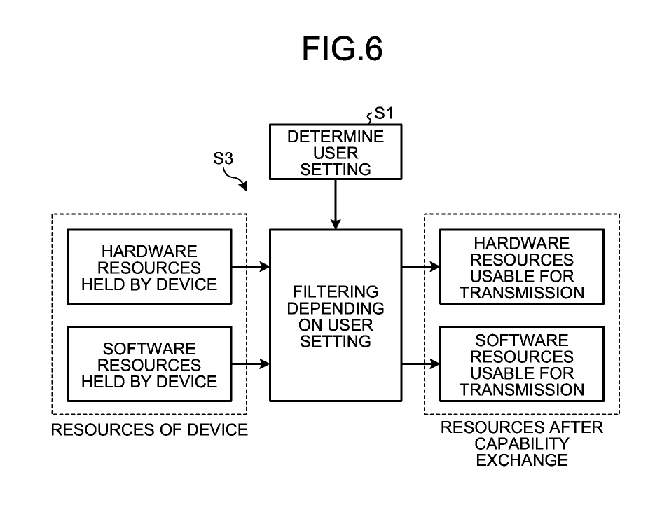

FIG. 6 is a schematic diagram exemplifying filtering at the capability exchange (S3). As illustrated in FIG. 6, at the capability exchange, the controller 103 may perform user-setting-dependant filtering on the hardware resources and the software resources based on the operation mode determined as the user setting at S1 to extract capabilities relating to the reproduction of the content in the operation mode, that is, hardware resources and software resources usable for transmission.

For example, filtering depending on the image-quality priority mode extracts capabilities relating to image quality at content reproduction (the display size, the resolution, the operation capability, the upscaling performance, the image filter performance, and the like) among the hardware resources and the software resources, as the hardware resources and the software resources usable for transmission. Similarly, for the frame-rate priority mode, extraction is performed for capabilities relating to frame rate at content reproduction (the frame-rate upper limit value, the operation capability, the frame interpolation capability, the skipping capability, and the like); for the low-delay mode, extraction is performed for capabilities relating to a processing time at content reproduction (the operation capability (operation time) and the like); and for the power-saving mode, extraction is performed for capabilities relating to power consumption at content reproduction (the power consumption, the presence or absence of a battery, and the like).

In the capability exchange, other than the above filtering, any capability of the communication device to be reported to the corresponding device may be reported as being variable. By reporting the capability of the communication device as being variable, the setting of the scaling adjustment and the frame rate adjustment during transmission may be changed. For example, when the communication device side is a television receiver and the display size of the communication device is 4K, the display size is reported as being 2K. Because of this, the corresponding device, which supports upscaling from 2K to 4K, transmits image data (content) of 2K without upscaling, based on the report from the communication device. The television receiver on the communication device side performs upscaling to 4K, and displays the content on the display 106 with the display size of 4K. By reporting the capability of the communication device to be intentionally reported to the corresponding device as being variable, for example, upscaling may be performed on the television receiver while upscaling is suppressed on a tablet type information terminal.

Next, the controller 103 checks the quality of the wireless line M1 based on information on signal intensity in the wireless communication module 102 or the like (S4). Next, the transmission parameter setting module 1031 determines a transmission method such as the setting of at least one of the scaling adjustment and the frame rate adjustment performed on the content on the communication device or the corresponding device based on the operation mode determined as the user setting at S1 and the quality of the wireless line M1 checked at S4 (S5).

### Image-Quality Priority Mode

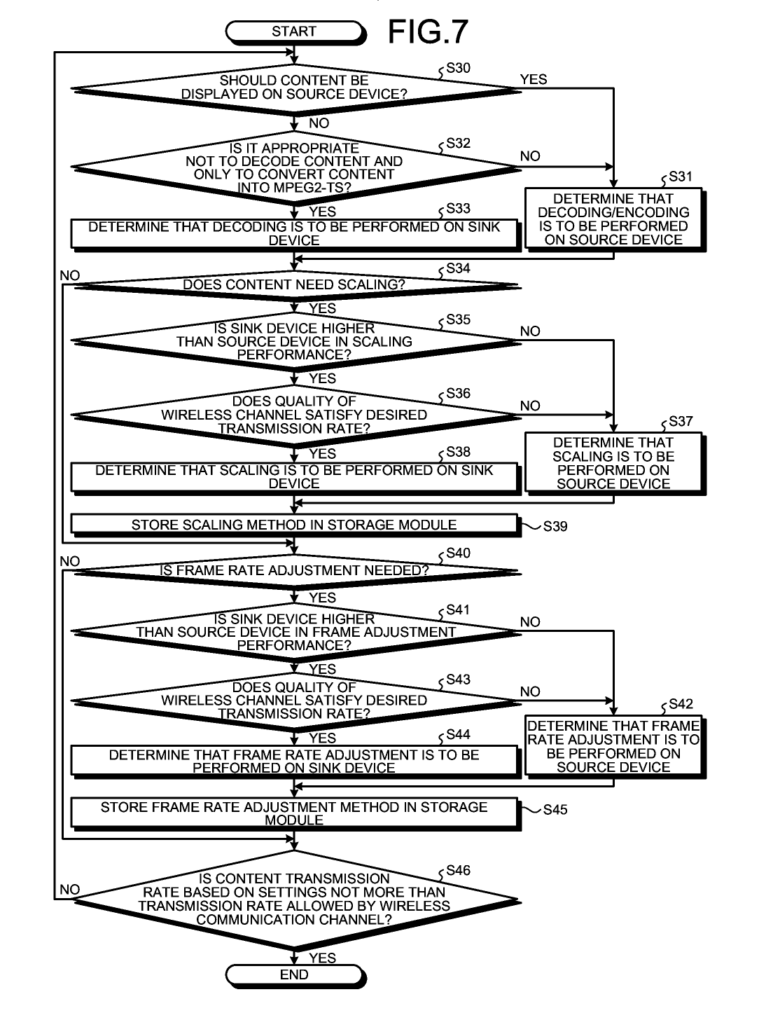

The following first describes the determination of the transmission method (S5) when the operation mode determined as the user setting at S1 is the image-quality priority mode. FIG. 7 is a flowchart illustrating an example of transmission method determination processing.

As illustrated in FIG. 7, upon starting of the processing, the transmission parameter setting module 1031 determines whether to display content to be transmitted on the source device (the communication device 100-1) (S30). If the content to be transmitted is set to be displayed on the source device through an operation on the operation module 105 or the like (Yes at S30), the transmission parameter setting module 1031 determines that decoding and encoding, which are to be performed when content is transmitted from the source device to the sink device (the communication device 100-2) and displayed by the sink device, as the decoding and encoding performed by the source device (S31).

If the display of content to be transmitted is not set (No at S30), the transmission parameter setting module 1031 determines whether it is appropriate that the content is not decoded and processed only with conversion into MPEG2-TS (S32). If the process only with conversion into MPEG2-TS is not appropriate (No at S32), the transmission parameter setting module 1031 determines that decoding and encoding are to be performed on the source device because decoding and encoding are needed on the source device side (S31). If the process only with conversion into MPEG2-TS is appropriate (Yes at S32), the transmission parameter setting module 1031 determines that decoding is to be performed on the sink device because decoding and encoding are not needed on the source device side (S33). The determination at S31 or S33 is reported to the corresponding device (the communication device 100-2) by communication through the wireless line M1.

Following S31 or S33, the transmission parameter setting module 1031 determines whether the content to be transmitted needs scaling (S34). Specifically, in the image-quality priority mode, if the display size of the corresponding device obtained through the capability exchange is larger than the display size of the content, the content is determined as content that needs upscaling (Yes at S34). In contrast, if the display size of the corresponding device is smaller than the display size of the content, in view that downscaling is prohibited, the content is determined as content that does not need the scaling (No at S34). For example, in view that the display size of the communication device 100-2 is 4K, it is determined that upscaling to 4K is needed if the display size of the content is 2K (1920×1080 pixels). If the content is determined as content that does not need the scaling (No at S34), the transmission parameter setting module 1031 advances the process to S40 with S35 to S39 skipped.

If the content is determined as content that needs the scaling (Yes at S34), the transmission parameter setting module 1031 determines whether the sink device is higher than the source device in scaling performance based on the information on the hardware resources and the software resource obtained through the capability exchange (S35). Specifically, in the image-quality priority mode, the operation capability relating to the scaling, the upscaling performance, and the image filter performance are compared between the sink device and the source device, and it is determined that either device side having the higher performance values has high scaling performance.

If the source device is higher than the sink device in the scaling performance (No at S35), in view that it has been checked at S25 that the transmission rate when the content is transmitted with the scaling adjustment and the frame rate adjustment performed on the source device (the communication device 100-1) side has no problem in terms of the quality of the wireless line M1, the transmission parameter setting module 1031 determines that the scaling adjustment is to be performed on the source device (S37).

If the sink device is higher than the source device in the scaling performance (Yes at S35), the transmission parameter setting module 1031 determines whether the quality of the wireless line M1 satisfies a desired transmission rate that is a transmission rate when the content is transmitted without the scaling adjustment performed on the content on the source device (S36). If the quality of the wireless line M1 satisfies the desired transmission rate (Yes at S36), in view that no block noise or the like occurs even when the scaling adjustment is performed on the sink device having the high scaling performance, the transmission parameter setting module 1031 determines that the scaling adjustment is to be performed on the sink device (S38). If the quality of the wireless line M1 does not satisfy the desired transmission rate (No at S36), in view of the fact that performing the scaling adjustment on the sink device makes block noise or the like likely to occur, the transmission parameter setting module 1031 determines that the scaling adjustment is to be performed on the source device (S37).

Following S37 or S38, the transmission parameter setting module 1031 stores the determined matter at S37 or S38 in a storage module allocated in a RAM or the like for storing a scaling method (S39). If it is determined that the scaling adjustment is to be performed on the sink device at S38, the transmission parameter setting module 1031 reports the determined matter that the scaling adjustment is to be performed on the sink device to the communication device 100-2 as the sink device through the wireless communication module 102. This causes the scaling adjustment on the transmitted content to be performed on the sink device side.

Subsequently, the transmission parameter setting module 1031 determines whether the content to be transmitted is content that needs the frame rate adjustment (S40). Specifically, in the image-quality priority mode, if the frame rate of the content is smaller than a preset frame rate (for example, 60 frames per second (fps)), the content is determined as content that needs the frame rate adjustment (Yes at S40). In contrast, if the frame rate of the content is larger than the preset frame rate, the content is determined as content that does not need the frame rate adjustment (No at S40). If the content is determined as content that does not need the frame rate adjustment (No at S40), the transmission parameter setting module 1031 advances the process to S46 with S41 to S45 skipped.

If the content is determined as content that needs the frame rate adjustment (Yes at S40), the transmission parameter setting module 1031 determines whether the sink device is higher than the source device in the frame rate adjustment performance based on the information on the hardware resources and the software resource obtained through the capability exchange (S41). Specifically, in the image-quality priority mode, the operation capability relating to the frame rate adjustment, the frame interpolation capability, the skipping capability, and the like are compared between the sink device and the source device, and it is determined that either device side having the higher performance values has high frame rate adjustment performance.

If the source device is higher than the sink device in the frame rate adjustment performance (No at S41), because it has been checked at S25 that the transmission rate when the content is transmitted with the scaling adjustment and the frame rate adjustment performed on the source device (the communication device 100-1) side has no problem in terms of the quality of the wireless line M1, the transmission parameter setting module 1031 determines that the frame rate adjustment is to be performed on the source device (S42).

If the sink device is higher than the source device in the frame rate adjustment performance (Yes at S41), the transmission parameter setting module 1031 determines whether the quality of the wireless line M1 satisfies a desired transmission rate that is a transmission rate of when the content is transmitted without the frame rate adjustment performed on the content on the source device (S43). If the quality of the wireless line M1 satisfies the desired transmission rate (Yes at S43), because no block noise or the like occurs even when the frame rate adjustment is performed on the sink device having the high frame rate adjustment performance, the transmission parameter setting module 1031 determines that the frame rate adjustment is to be performed on the sink device (S44). If the quality of the wireless line M1 does not satisfy the desired transmission rate (No at S43), because performing the frame rate adjustment on the sink device makes block noise or the like likely to occur, the transmission parameter setting module 1031 determines that the frame rate adjustment is to be performed on the source device (S42).

Following S42 or S44, the transmission parameter setting module 1031 stores the determined matter at S42 or S44 in a storage module allocated in a RAM or the like for storing a frame rate adjustment method (S45). If it is determined that the frame rate adjustment is to be performed on the sink device at S44, the transmission parameter setting module 1031 reports the determined matter that the scaling adjustment is to be performed on the sink device to the communication device 100-2 as the sink device through the wireless line M1. This causes the frame rate adjustment on the transmitted content to be performed on the sink device side.

Subsequently, the transmission parameter setting module 1031 determines whether a content transmission rate based on the settings at S39 and S45 is not more than a transmission rate allowed by the quality of the wireless line M1 (S46). Specifically, the transmission parameter setting module 1031 calculates a transmission rate allowed in the wireless line M1 based on information on signal intensity in the wireless communication module 102 or the like, and determines whether the transmission rate exceeds a transmission rate estimated when the scaling adjustment or the frame rate adjustment is performed on the sink device or the source device based on the settings at S39 and S45. If the content transmission rate is not more than the transmission rate allowed by the quality of the wireless line M1 (Yes at S46), because there is no likelihood of block noise or the like occurring, the transmission parameter setting module 1031 determines the transmission method based on the settings of S39 and S45 and ends the process. If the content transmission rate exceeds the transmission rate allowed by the quality of the wireless line M1 (No at S46), because there is a likelihood of block noise or the like occurring, the transmission parameter setting module 1031 returns the process to S30 to repeat the processing.

As described above, when the image-quality priority mode is set, the scaling adjustment is set to be performed on the content within a range capable of transmitting the content with a transmission rate that is based on the communication state of the wireless line M1 and to be performed on one of the source device and the sink device with a superior scaling adjustment capability. This causes the content to be reproduced according to the communication state of the wireless line M1 in the image-quality priority mode desired by a user.

### Frame-Rate Priority Mode

The following describes the determination of the transmission method (S5) when the operation mode determined as the user setting at S1 is the frame-rate priority mode.

As illustrated in FIG. 7, the transmission parameter setting module 1031 performs the same processing as in the image-quality priority mode until S31 or S33. Following S31 or S33, the transmission parameter setting module 1031 determines whether content to be transmitted is content that needs the scaling (S34). Specifically, in the frame-rate priority mode, if the display size of the corresponding device obtained through the capability exchange differs from the display size of the content, the content is determined as content that needs the scaling (Yes at S34). In contrast, if the display size of the corresponding device and the display size of the content are the same, the content is determined as content that does not need the scaling (No at S34). If the content is determined as content that does not need scaling (No at S34), the transmission parameter setting module 1031 advances the process to S40 with S35 to S39 skipped.

If the content is determined as content that needs the scaling (Yes at S34), the transmission parameter setting module 1031 determines whether the sink device is higher than the source device in the scaling performance based on the information on the hardware resources and the software resource obtained through the capability exchange (S35). Specifically, in the frame-rate priority mode, the operation capability relating to the scaling, the upscaling performance, and the image filter performance are compared between the sink device and the source device, and it is determined that either device having the higher performance values has high scaling performance.

If the source device is higher than the sink device in the scaling performance (No at S35), because it has been checked at S25 that the transmission rate of when the content is transmitted with the scaling adjustment and the frame rate adjustment performed on the source device (the communication device 100-1) side has no problem in terms of the quality of the wireless line M1, the transmission parameter setting module 1031 determines that the scaling adjustment is to be performed on the source device (S37).

If the sink device is higher than the source device in the scaling performance (Yes at S35), the transmission parameter setting module 1031 determines whether the quality of the wireless line M1 satisfies a desired transmission rate, that is a transmission rate of when the content is transmitted without the scaling adjustment performed on the content by the source device (S36). If the quality of the wireless line M1 satisfies the desired transmission rate (Yes at S36), because no block noise or the like occurs even when the scaling adjustment is performed on the sink device having the high scaling performance, the transmission parameter setting module 1031 determines that the scaling adjustment is to be performed by the sink device (S38). If the quality of the wireless line M1 does not satisfy the desired transmission rate (No at S36), because performing the scaling adjustment on the sink device makes block noise or the like likely to occur, the transmission parameter setting module 1031 determines that the scaling adjustment is to be performed by the source device (S37).

Following S37 or S38, the transmission parameter setting module 1031 stores the determined matter at S37 or S38 in a storage module allocated in a RAM or the like for storing the scaling method (S39). If it is determined that the scaling adjustment is to be performed by the sink device at S38, the transmission parameter setting module 1031 reports the determined matter that the scaling adjustment is to be performed by the sink device to the communication device 100-2 as the sink device through the wireless communication module 102. This causes the scaling adjustment on the transmitted content to be performed by the sink device side.

Subsequently, the transmission parameter setting module 1031 determines whether the content to be transmitted is content that needs the frame rate adjustment (S40). Specifically, in the frame-rate priority mode, the content is determined as content that needs the frame rate adjustment up to the frame-rate upper limit value in the hardware resources (Yes at S40).

In the frame-rate priority mode (Yes at S40), the transmission parameter setting module 1031 determines whether the sink device is higher than the source device in the frame rate adjustment performance based on the information on the hardware resources and the software resource obtained through the capability exchange (S41). Specifically, in the frame-rate priority mode, the operation capability relating to the frame rate adjustment, the frame interpolation capability, the skipping capability, and the like are compared between the sink device and the source device, and it is determined that either device side having the higher performance values has high frame rate adjustment performance.

If the source device is higher than the sink device in the frame rate adjustment performance (No at S41), because it has been checked at S25 that the transmission rate of when the content is transmitted with the scaling adjustment and the frame rate adjustment performed on the source device (the communication device 100-1) side has no problem in terms of the quality of the wireless line M1, the transmission parameter setting module 1031 determines that the frame rate adjustment is to be performed by the source device (S42).

If the sink device is higher than the source device in the frame rate adjustment performance (Yes at S41), the transmission parameter setting module 1031 determines whether the quality of the wireless line M1 satisfies a desired transmission rate, that is a transmission rate of when the content is transmitted without the frame rate adjustment performed on the content on the source device (S43). If the quality of the wireless line M1 satisfies the desired transmission rate (Yes at S43), because no block noise or the like occurs even when the frame rate adjustment is performed by the sink device having the higher frame rate adjustment performance, the transmission parameter setting module 1031 determines that the frame rate adjustment is to be performed by the sink device (S44). If the quality of the wireless line M1 does not satisfy the desired transmission rate (No at S43), because performing the frame rate adjustment on the sink device makes block noise or the like likely to occur, the transmission parameter setting module 1031 determines that the frame rate adjustment is to be performed on the source device (S42).

Following S42 or S44, the transmission parameter setting module 1031 stores the determined matter at S42 or S44 in a storage module allocated in a RAM or the like for storing the frame rate adjustment method (S45). If it is determined that the frame rate adjustment is to be performed by the sink device at S44, the transmission parameter setting module 1031 reports the determined matter that the scaling adjustment is to be performed on the sink device to the communication device 100-2 as the sink device through the wireless line M1. This causes the frame rate adjustment on the transmitted content to be performed on the sink device side.

Subsequently, the transmission parameter setting module 1031 determines whether a content transmission rate based on the settings at S39 and S45 is not more than a transmission rate allowed by the quality of the wireless line M1 (S46). Specifically, the transmission parameter setting module 1031 calculates a transmission rate allowed in the wireless line M1 based on information on signal intensity in the wireless communication module 102 or the like, and determines whether the transmission rate exceeds a transmission rate estimated when the scaling adjustment or the frame rate adjustment is performed on the sink device or the source device based on the settings at S39 and S45. If the content transmission rate is not more than the transmission rate allowed by the quality of the wireless line M1 (Yes at S46), because there is no likelihood of block noise or the like occurring, the transmission parameter setting module 1031 determines the transmission method based on the settings of S39 and S45, and ends the processing. If the content transmission rate exceeds the transmission rate allowed by the quality of the wireless line M1 (No at S46), because there is a likelihood of block noise or the like occurring, the transmission parameter setting module 1031 returns the process to S30 to repeat the processing.

As described above, when the frame-rate priority mode is set, the scaling adjustment on the content is set to be performed within a range capable of transmitting the content at a transmission rate that is based on the communication state of the wireless line M1 and to be performed by one of the source device and the sink device with a superior frame rate adjustment capability. This causes the content to be reproduced according to the communication state of the wireless line M1 in the frame-rate priority mode desired by a user.

### Low-Delay Mode

The following describes the determination of the transmission method (S5) of when the operation mode determined as the user setting at S1 is the low-delay mode.

As illustrated in FIG. 7, the transmission parameter setting module 1031 performs the same processing as in the image-quality priority mode until S31 or S33. Following S31 or S33, the transmission parameter setting module 1031 determines whether content to be transmitted is content that needs the scaling (S34). Specifically, in the low-delay mode, it is determined whether operation time required for the scaling of the corresponding device obtained through the capability exchange or operation time required for the scaling of the communication device is within time set as a delay time in advance. If the operation time is within the time set as the delay time and the display size differs from the display size of the content, the content is determined as content that needs the scaling (Yes at S34).

If the operation time is not within the time set as the delay time, the content is determined as content that does not need the scaling (No at S34). If the content is determined as content that does not need the scaling (No at S34), the transmission parameter setting module 1031 advances the process to S40 with S35 to S39 skipped.

If the content is determined as content that needs the scaling (Yes at S34), the transmission parameter setting module 1031 determines whether the sink device is higher than the source device in the scaling performance based on the information on the hardware resources and the software resource obtained through the capability exchange (S35). Specifically, in the low-delay mode, the operation capability (operation time) relating to the scaling is compared between the sink device and the source device, and it is determined that either device having the higher performance value has high scaling performance.

If the source device is higher than the sink device in the scaling performance (No at S35), because it has been checked at S25 that the transmission rate of when the content is transmitted with the scaling adjustment and the frame rate adjustment performed on the source device (the communication device 100-1) side has no problem in terms of the quality of the wireless line M1, the transmission parameter setting module 1031 determines that the scaling adjustment is to be performed by the source device (S37).

If the sink device is higher than the source device in the scaling performance (Yes at S35), the transmission parameter setting module 1031 determines whether the quality of the wireless line M1 satisfies a desired transmission rate, that is a transmission rate of when the content is transmitted without the scaling adjustment performed on the content by the source device (S36). If the quality of the wireless line M1 satisfies the desired transmission rate (Yes at S36), because no block noise or the like occurs even when the scaling adjustment is performed by the sink device having the high scaling performance, the transmission parameter setting module 1031 determines that the scaling adjustment is to be performed by the sink device (S38). If the quality of the wireless line M1 does not satisfy the desired transmission rate (No at S36), because performing the scaling adjustment on the sink device makes block noise or the like likely to occur, the transmission parameter setting module 1031 determines that the scaling adjustment is to be performed by the source device (S37).

Following S37 or S38, the transmission parameter setting module 1031 stores the determined matter at S37 or S38 in a storage module allocated in a RAM or the like for storing the scaling method (S39). If it is determined that the scaling adjustment is to be performed on the sink device at S38, the transmission parameter setting module 1031 reports the determined matter that the scaling adjustment is to be performed by the sink device to the communication device 100-2 as the sink device through the wireless communication module 102. This causes the scaling adjustment on the transmitted content to be performed by the sink device side.

Subsequently, the transmission parameter setting module 1031 determines whether the content to be transmitted is content that needs the frame rate adjustment (S40). Specifically, in the low-delay mode, it is determined that operation time required for the frame rate adjustment of the corresponding device obtained through the capability exchange or operation time required for the frame rate adjustment of the communication device is within time set as a delay time in advance. If the operation time is within the time set as the delay time and the frame rate of the content is smaller than a preset frame rate, the content is determined as content that needs frame rate adjustment (Yes at S40).

If the operation time is not within the time set as the delay time, the content is determined as content that does not need the frame rate adjustment (No at S40). If the content is determined as content that does not need the frame rate adjustment (No at S40), the transmission parameter setting module 1031 advances the process to S46 with S41 to S45 skipped.

If the content is determined as content that needs the frame rate adjustment (Yes at S40), the transmission parameter setting module 1031 determines whether the sink device is higher than the source device in the frame rate adjustment performance based on the information on the hardware resources and the software resource obtained through the capability exchange (S41). Specifically, in the low-delay mode, the operation capability (operation time) relating to the frame rate adjustment is compared between the sink device and the source device, and it is determined that either device having the higher performance value has high frame rate adjustment performance.

If the source device is higher than the sink device in the frame rate adjustment performance (No at S40), because it has been checked at S25 that the transmission rate of when the content is transmitted with the scaling adjustment and the frame rate adjustment performed by the source device (the communication device 100-1) side has no problem in terms of the quality of the wireless line M1, the transmission parameter setting module 1031 determines that the frame rate adjustment is to be performed by the source device (S42).

If the sink device is higher than the source device in the frame rate adjustment performance (Yes at S40), the transmission parameter setting module 1031 determines whether the quality of the wireless line M1 satisfies a desired transmission rate, that is a transmission rate of when the content is transmitted without the frame rate adjustment performed by the source device (S43). If the quality of the wireless line M1 satisfies the desired transmission rate (Yes at S43), because no block noise or the like occurs even when the frame rate adjustment is performed by the sink device having the higher frame rate adjustment performance, the transmission parameter setting module 1031 determines that the frame rate adjustment is to be performed by the sink device (S44). If the quality of the wireless line M1 does not satisfy the desired transmission rate (No at S43), because performing the frame rate adjustment by the sink device makes block noise or the like likely to occur, the transmission parameter setting module 1031 determines that the frame rate adjustment is to be performed by the source device (S42).

Following S42 or S44, the transmission parameter setting module 1031 stores the determined matter at S42 or S44 in a storage module allocated in a RAM or the like for storing the frame rate adjustment method (S45). If it is determined that the frame rate adjustment is to be performed by the sink device at S44, the transmission parameter setting module 1031 reports the determined matter that the frame rate adjustment is to be performed by the sink device to the communication device 100-2 as the sink device through the wireless line M1. This causes the frame rate adjustment on the transmitted content to be performed by the sink device side.

Subsequently, the transmission parameter setting module 1031 determines whether a content transmission rate based on the settings at S39 and S45 is not more than a transmission rate allowed by the quality of the wireless line M1 (S46). Specifically, the transmission parameter setting module 1031 calculates a transmission rate allowed in the wireless line M1 based on information on signal intensity in the wireless communication module 102 or the like, and determines whether the transmission rate exceeds a transmission rate estimated when the scaling adjustment or the frame rate adjustment is performed by the sink device or the source device based on the settings at S39 and S45. If the content transmission rate is not more than the transmission rate allowed by the quality of the wireless line M1 (Yes at S46), because there is no likelihood of block noise or the like occurring, the transmission parameter setting module 1031 determines the transmission method based on the settings of S39 and S45, and ends the processing. If the content transmission rate exceeds the transmission rate allowed by the quality of the wireless line M1 (No at S46), because there is a likelihood of block noise or the like occurring, the transmission parameter setting module 1031 returns the process to S30 to repeat the processing.

As described above, when the low-delay mode is set, at least one of the scaling adjustment and the frame rate adjustment on the content is set to be performed within a range capable of transmitting the content at a transmission rate that is based on the communication state of the wireless line M1 and to be performed by one of the sink device and the source device with a shorter processing time. This causes the content to be reproduced in the low-delay mode desired by a user and according to the communication state of the wireless line M1.

### Power-Saving Mode

The following describes the determination of the transmission method (S5) of when the operation mode determined as the user setting at S1 is the power-saving mode.

As illustrated in FIG. 7, the transmission parameter setting module 1031 performs the same processing as in the image-quality priority mode until S31 or S33. Following S31 or S33, the transmission parameter setting module 1031 determines whether content to be transmitted is content that needs the scaling (S34). Specifically, in the power-saving mode, it is determined whether power consumption required for the scaling of the corresponding device obtained through the capability exchange or power consumption required for the scaling of the communication device is within a threshold set as power consumption in advance. If the power consumption is within the threshold and the display size differs from the display size of the content, the content is determined as content that needs the scaling (Yes at S34).

If the power consumption is not within the threshold, the content is determined as content that does not need the scaling (No at S34). If the content is determined as content that does not need the scaling (No at S34), the transmission parameter setting module 1031 advances the process to S40 with S35 to S39 skipped.

If the content is determined as content that needs the scaling (Yes at S34), the transmission parameter setting module 1031 determines whether the sink device is higher than the source device in the scaling performance based on the information on the hardware resources and the software resource obtained through the capability exchange (S35). Specifically, in the power-saving mode, power consumption relating to the scaling and the presence or absence of battery drive are compared between the sink device and the source device, and it is determined that either device that is not battery-driven and reduces power consumption has high scaling performance.

If the source device is higher than the sink device in the scaling performance (No at S35), because it has been checked at S25 that the transmission rate of when the content is transmitted with the scaling adjustment and the frame rate adjustment performed by the source device (the communication device 100-1) side has no problem in terms of the quality of the wireless line M1, the transmission parameter setting module 1031 determines that the scaling adjustment is to be performed by the source device (S37).

If the sink device is higher than the source device in the scaling performance (Yes at S35), the transmission parameter setting module 1031 determines whether the quality of the wireless line M1 satisfies a desired transmission rate that is a transmission rate of when the content is transmitted without the scaling adjustment performed by the source device (S36). If the quality of the wireless line M1 satisfies the desired transmission rate (Yes at S36), because no block noise or the like occurs even when the scaling adjustment is performed by the sink device having the high scaling performance, the transmission parameter setting module 1031 determines that the scaling adjustment is to be performed by the sink device (S38). If the quality of the wireless line M1 does not satisfy the desired transmission rate (No at S36), because performing the scaling adjustment on the sink device makes block noise or the like likely to occur, the transmission parameter setting module 1031 determines that the scaling adjustment is to be performed by the source device (S37).

Following S37 or S38, the transmission parameter setting module 1031 stores the determined matter at S37 or S38 in a storage module allocated in a RAM or the like for storing the scaling method (S39). If it is determined that the scaling adjustment is to be performed by the sink device at S38, the transmission parameter setting module 1031 reports the determined matter that the scaling adjustment is to be performed by the sink device to the communication device 100-2 as the sink device through the wireless communication module 102. This causes the scaling adjustment on the transmitted content to be performed by the sink device side.

Subsequently, the transmission parameter setting module 1031 determines whether the content to be transmitted is content that needs the frame rate adjustment (S40). Specifically, in the power-saving mode, it is determined that power consumption required for the frame rate adjustment of the corresponding device obtained through the capability exchange or power consumption required for the frame rate adjustment of the communication device is within a threshold set as power consumption in advance. If the power consumption is within the threshold and the frame rate of the content is smaller than a preset frame rate, the content is determined as content that needs scaling (Yes at S40).

If the power consumption is not within the threshold, the content is determined as content that does not need the frame rate adjustment (No at S40). If the content is determined as content that does not need the frame rate adjustment (No at S40), the transmission parameter setting module 1031 advances the process to S40 with S35 to S39 skipped.

If the content is determined as content that needs the frame rate adjustment (Yes at S40), the transmission parameter setting module 1031 determines whether the sink device is higher than the source device in the frame rate adjustment performance based on the information on the hardware resources and the software resource obtained through the capability exchange (S41). Specifically, in the power-saving mode, power consumption relating to the frame rate adjustment and the presence or absence of battery drive are compared between the sink device and the source device, and it is determined that either device that is not battery-driven and reduces power consumption has high frame rate adjustment performance.

If the source device is higher than the sink device in the frame rate adjustment performance (No at S41), because it has been checked at S25 that the transmission rate of when the content is transmitted with the scaling adjustment and the frame rate adjustment performed by the source device (the communication device 100-1) side has no problem in terms of the quality of the wireless line M1, the transmission parameter setting module 1031 determines that the frame rate adjustment is to be performed by the source device (S42).

If the sink device is higher than the source device in the frame rate adjustment performance (Yes at S41), the transmission parameter setting module 1031 determines whether the quality of the wireless line M1 satisfies a desired transmission rate that is a transmission rate of when the content is transmitted without the frame rate adjustment performed by the source device (S43). If the quality of the wireless line M1 satisfies the desired transmission rate (Yes at S43), because no block noise or the like occurs even when the frame rate adjustment is performed by the sink device having the higher frame rate adjustment performance, the transmission parameter setting module 1031 determines that the frame rate adjustment is to be performed by the sink device (S44). If the quality of the wireless line M1 does not satisfy the desired transmission rate (No at S43), because performing the frame rate adjustment by the sink device makes block noise or the like likely to occur, the transmission parameter setting module 1031 determines that the frame rate adjustment is to be performed by the source device (S42).

Following S42 or S44, the transmission parameter setting module 1031 stores the determined matter at S42 or S44 in a storage module allocated in a RAM or the like for storing the scaling method (S45). If it is determined that the frame rate adjustment is to be performed by the sink device at S44, the transmission parameter setting module 1031 reports the determined matter that the frame rate adjustment is to be performed by the sink device to the communication device 100-2 as the sink device through the wireless line M1. This causes the frame rate adjustment on the transmitted content to be performed by the sink device side.

Subsequently, the transmission parameter setting module 1031 determines whether a content transmission rate based on the settings at S39 and S45 is not more than a transmission rate allowed by the quality of the wireless line M1 (S46). Specifically, the transmission parameter setting module 1031 calculates a transmission rate allowed in the wireless line M1 based on information on signal intensity in the wireless communication module 102 or the like, and determines whether the transmission rate exceeds a transmission rate estimated when the scaling adjustment or the frame rate adjustment is performed by the sink device or the source device based on the settings at S39 and S45. If the content transmission rate is not more than the transmission rate allowed by the quality of the wireless line M1 (Yes at S46), because there is no likelihood of block noise or the like occurring, the transmission parameter setting module 1031 determines the transmission method based on the settings of S39 and S45, and ends the processing. If the content transmission rate exceeds the transmission rate allowed by the quality of the wireless line M1 (No at S46), because there is a likelihood of block noise or the like occurring, the transmission parameter setting module 1031 returns the process to S30 to repeat the processing.

As described above, when the power-saving mode is set, at least one of the scaling adjustment and the frame rate adjustment is set to be performed within a range capable of transmitting the content with a transmission rate that is based on the communication state of the wireless line M1 and to be performed on one of the sink device and the source device which reduces power consumption or which is not driven on a battery. This causes the content to be reproduced in the power-saving mode desired by a user and according to the communication state of the wireless line M1.

Returning back to FIG. 4, after determining the transmission methods for the respective operation modes determined as the user setting (the image-quality priority mode, the frame-rate priority mode, the low-delay mode, and the power-saving mode), the controller 103 determines whether the content to be transmitted is content to be protected by copyright and content protection needs to be implemented (S6).

If the content protection does not need to be implemented (No at S6), the controller 103 advances the process to S8. If the content protection needs to be implemented (Yes at S6), the controller 103 prepared for transmission for content protection including round trip time (RTT) measurement (S7), and advances the process to S8.

At S8, the controller 103 determines whether the transmission of the content through the wireless line M1 is to be started (S8). If the content transmission preparations are not completed and the transmission of the content cannot be started (No at S8), the controller 103 returns the process to S1. If the content transmission preparations are completed (Yes at S8), the controller 103 starts or continues the transmission of the content through the wireless line M1 (S9). This causes the content transmitted from the communication device 100-1 to be reproduced on the communication device 100-2 side according to the transmission method determined at S5.

While the transmission of the content continues, the controller 103 determines whether the quality (transmission rate) of the wireless line M1 is a desired value that is a transmission rate for transmitting the content according to the transmission method determined at S5, or more based on information on signal intensity in the wireless communication module 102 or the like (S10). If the quality of the wireless line M1 is less than the desired value (No at S10), the controller 103 returns the process to S4 and determines again the transmission method according to the quality of the wireless line M1.

If the quality of the wireless line M1 is the desired value or more (Yes at S10), the controller 103 determines whether the transmission of the content is completed (suspended) because the reproduction of the content has been completed (suspended) (S11). If the transmission of the content is not completed (suspended) (No at S11), the controller 103 returns the process to S9 to continue the transmission of the content. The controller 103 performs the processing of S10 and S11 in a cycle of, for example, a few seconds. Thus, a transmission method according to change over time in the quality of the wireless line M1 is determined. If the transmission of the content is completed (suspended) (Yes at S11), the controller 103 ends the processing.

A computer program to be executed on the communication devices 100-1, 100-2 of the present embodiment is provided incorporated into a ROM or the like in advance. The computer program to be executed on the communication devices 100-1, 100-2 of the present embodiment may be recorded in a computer-readable recording medium such as a CD-ROM, a flexible disk (FD), a CD-R, and a digital versatile disc (DVD) as a file in an installable format or an executable format to be provided.

The computer program to be executed on the communication devices 100-1, 100-2 of the present embodiment may be provided by storing it in a computer connected to a network such as the Internet and downloading it through the network. The computer program to be executed on the communication devices 100-1, 100-2 of the present embodiment may be provided or distributed through a network such as the Internet.

The computer program to be executed on the communication devices 100-1, 100-2 of the present embodiment is a module configuration comprising the above-described functional configuration. As actual hardware, a CPU (a processor) reads the program from the ROM and executes it, thereby causing the above-described functional configuration to be loaded into and generated in a main storage.

Moreover, the various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A communication device comprising:
a communication module configured to wirelessly transmit content;
a mode setting module configured to set one of operation modes relating to reproduction of the content;
a receiver configured to receive pieces of information indicating capabilities from a corresponding device to which the content is transmitted;
a transmission setting module configured to set, based on capability of the communication device and the corresponding device and within a range capable of transmitting the content at a transmission rate that is based on a communication state of the wireless transmission, at least one of scaling adjustment and frame rate adjustment to be performed by one of the communication device and the corresponding device with superior capability, the scaling adjustment and the frame rate adjustment being configured to be performed on the content upon transmission of the content when the content is reproduced in the set one of the operation modes; and
a reporting module configured to report, when the at least one of the scaling adjustment and the frame rate adjustment is set to be performed by the corresponding device, the setting to the corresponding device.

2. The communication device of claim 1, wherein the transmission setting module is configured to set at least one of the scaling adjustment and the frame rate adjustment to be performed on the content that are performed by one of the communication device and the corresponding device according to change over time in the communication state of the wireless transmission.

3. The communication device of claim 1, wherein
the operation modes comprises an image-quality priority mode in which image quality is prioritized for the content reproduction, and
the transmission setting module is configured to set, when the image-quality priority mode is set, the scaling adjustment to be performed by one of the communication device and the corresponding device with a superior scaling adjustment capability.

4. The communication device of claim 1, wherein
the operation mode comprises a frame-rate priority mode in which a frame rate is increased for the content reproduction, and
the transmission setting module is configured to set, when the frame-rate priority mode is set, the frame rate adjustment to be performed by one of the communication device and the corresponding device with a superior frame rate adjustment capability.

5. The communication device of claim 1, wherein
the operation mode comprises a low-delay mode in which a delay time is reduced for the content reproduction, and
the transmission setting module is configured to set, when the low-delay mode is set, at least one of the scaling adjustment and the frame rate adjustment to be performed by one of the communication device and the corresponding device with a shorter processing time.

6. The communication device of claim 1, wherein
the operation mode comprises a power-saving mode in which power consumption is reduced for the content reproduction, and
the transmission setting module is configured to set at least one of the scaling adjustment and the frame rate adjustment to be performed by one of the communication device and the corresponding device that is configured to reduce power consumption or is not operated by battery.

7. The communication device of claim 1, wherein the scaling adjustment is configured to upscale content with a resolution of less than 4K (4096×2160 pixels) to a resolution of 4K.

8. The communication device of claim 1, further comprising an extracting module configured to extract information indicating capability relating to the reproduction of the content in the set operation mode from among the received pieces of information indicating capability.

9. The communication device of claim 1, wherein, upon setting the at least one of the scaling adjustment and the frame rate adjustment to be performed by one of the communication device and the corresponding device based on the capability of the communication device and the corresponding device, the setting by the transmission setting module is changed by making the capability of the communication device to be reported to the corresponding device variable.

10. The communication device of claim 1, further comprising:
a display configured to display a video of the content;
an image processor configured to perform one of the scaling adjustment and the frame rate adjustment on a video corresponding to the video displayed on the display; and
an encoder configured to encode the video processed by the image processor, wherein
the communication module is configured to transmit the video encoded by the encoder to the corresponding device.

11. The communication device of claim 1, further comprising:
a storage module configured to store therein a file name or a program name of the content and the operation mode corresponding to the file name or the program name, wherein
the transmission setting module is configured set at least one of the scaling adjustment and the frame rate adjustment to be performed by one of the communication device and the corresponding device, the scaling adjustment and the frame rate adjustment being configured to be performed on the content when the content is reproduced in one of the operation modes set in accordance with the file name or the program name of the content.

12. The communication device of claim 11, further comprising:
an input module configured to receive an input of an operation mode from a user, wherein
the storage module is configured to store therein the file name or the program name of the content and the operation mode received by the input module.

13. A communication method of a communication device comprising a communication module configured to wirelessly transmit content, the communication method comprising:
setting, by a mode setting module, one of operation modes relating to reproduction of the content;
receiving, by a receiver, pieces of information indicating capabilities from a corresponding device to which the content is transmitted;
setting, by a transmission setting module and based on capability of the communication device and the corresponding device and within a range capable of transmitting the content at a transmission rate that is based on a communication state of the wireless transmission, at least one of the scaling adjustment and frame rate adjustment to be performed by one of the communication device and the corresponding device with superior capability, the scaling adjustment and the frame rate adjustment being configured to be performed on the content upon transmission of the content when the content is reproduced in the set one of the operation modes; and
reporting, by a reporting module, when the at least one of the scaling adjustment and the frame rate adjustment is set to be performed by the corresponding device, the setting to the corresponding device.

14. A computer program product having a non-transitory computer readable medium including programmed instructions, wherein the instructions, when executed by a computer of a communication device comprising a communication module configured to wirelessly transmit content, cause the computer to perform:
setting, by a mode setting module, one of operation modes relating to reproduction of the content;
receiving, by a receiver, pieces of information indicating capabilities from a corresponding device to which the content is transmitted;
setting, by a transmission setting module and based on capability of the communication device and the corresponding device and within a range capable of transmitting the content at a transmission rate that is based on a communication state of the wireless transmission, at least one of the scaling adjustment and frame rate adjustment to be performed by one of the communication device and the corresponding device with superior capability, the scaling adjustment and the frame rate adjustment being configured to be performed on the content upon transmission of the content when the content is reproduced in the set one of the operation modes; and
reporting, by a reporting module, when the at least one of the scaling adjustment and the frame rate adjustment is set to be performed by the corresponding device, the setting to the corresponding device.
